(19) United States
(12) Patent Application Publication
(10) Pub. No.: US 2015/0107974 A1
(43) Pub. Date: Apr. 23, 2015

(54) KEYBOARD EQUIPPED WITH LIGHT EMITTING STRUCTURE

(71) Applicant: ZIPPY TECHNOLOGY CORP., New Taipei City (TW)

(72) Inventors: Yu-Chun HUANG, New Taipei City (TW); TUNG-HSING WU, New Taipei City (TW); Chin-Hsiu HWA, New Taipei City (TW)

(73) Assignee: ZIPPY TECHNOLOGY CORP., New Taipei Ctiy (TW)

(21) Appl. No.: 14/060,371

(22) Filed: Oct. 22, 2013

(51) Int. Cl. H01H 13/83

(52) U.S. Cl. CPC H01H 13/83; H01H 2219/036; H01H 2219/062; H01H 2219/06
USPC 200/5 A

(57) ABSTRACT

A keyboard equipped with light emitting structure comprises a plurality of keycap portions and a light guide command circuit board which includes an upper light guide plate, a lower light guide plate and a middle plate located between the upper and lower light guide plates. The upper and lower light guide plates have respectively an upper trigger portion and a lower trigger portion at one side facing the middle plate. The middle plate has a hollow zone corresponding to the upper and lower trigger portions, a plurality of coupling portions corresponding to the keycap portion and a plurality of apertures. The upper light guide plate also has an upper mask layer at one side facing the keycap portion and having a transparent zone. The command circuit board receives light from a light emitting unit and transmits the light to illuminate the keycap portion through the transparent zone.

### FIELD OF THE INVENTION

The present invention relates to a keyboard and particularly to a keyboard equipped with light emitting structure.

### BACKGROUND OF THE INVENTION

Among numerous types of keyboards now available on the market, illuminated keyboards integrated with light emitting modules have been provided by some producers to meet different consumers' requirements and make them more appealing to the consumers with this additional feature. The conventional illuminated keyboards mostly adopt a light guide plate for the keyboard light emitting module. References can be found in U.S. Pat. Nos. 6,217,183, 6,467,924, 6,918,677, 7,172,303, 7,193,535, 7,172,303, 7,283,066 and 6,860,612.

However, with the prevailing trend of electronic products that heavily focuses on slim and light, now many producers, in additional to developing the illuminated keyboard, also devote a great deal of research and development on reducing total thickness of the keyboard module.

To improve the drawback of increasing the total keyboard thickness caused by using the light guide plate as the light emitting module, Taiwan publication No. 201320135 and Taiwan patent Nos. 1345719 and 1399776 propose a light emitting module that directly uses a circuit board made of light guide material. However, in order to generate uniform overall illumination an extra light guide structure usually is needed, such as reflective bulged spots. Such additional feature eventually makes reducing keyboard thickness unattainable. Moreover, the illuminated keyboards now commonly adopted in the industry, in addition to the aforesaid light guide structure, also include a plurality of coupling elements and a baseboard to hold the coupling elements to ensure that each key can be depressible and restore effectively. The baseboard and coupling elements are formed at a certain height. Hence, with the constraints of the light guide structure, baseboard and coupling elements, slimness of the illuminated keyboard becomes very difficult.

### SUMMARY OF THE INVENTION

The primary object of the present invention is to overcome the thickness problem occurring to the conventional illuminated keyboards.

To achieve the foregoing object, the invention provides a keyboard equipped with light emitting structure that comprises a plurality of keycap portions, a plurality of driven mechanisms each corresponding to one keycap portion, a light guide command circuit board and a light emitting unit. The command circuit board includes an upper light guide plate, a lower light guide plate and a middle plate located between the upper and lower light guide plates. The upper light guide plate and lower light guide plate have respectively an upper trigger portion and a lower trigger portion at one side facing the middle plate that can be triggered to generate a command signal. The middle plate has a hollow zone corresponding to the upper and lower trigger portions, a plurality of coupling portions corresponding to the keycap portion to couple with the driven mechanism, and a plurality of apertures corresponding to the coupling portions. The upper light guide plate also has an upper mask layer at one side facing the keycap portion. The upper mask layer has a transparent zone corresponding to the keycap portion. The light emitting unit provides light to the command circuit board. The command circuit board receives the light and transmits the light evenly to illuminate the keycap portion through the transparent zone.

In one embodiment the lower light guide plate has a lower reflective layer at one side opposing the lower trigger portion.

In another embodiment the lower light guide plate has a lower reflective layer at same side of the lower trigger portion.

In yet another embodiment the upper light guide plate has an upper reflective layer below the upper mask layer.

In yet another embodiment the upper light guide plate has an upper reflective layer at same side of the upper trigger portion.

In yet another embodiment the lower light guide plate has a lower mask layer below the lower reflective layer.

In yet another embodiment the middle plate has an upper insulation layer and a lower insulation layer respectively at one side facing the upper trigger portion and lower trigger portion, and the upper insulation layer and lower insulation layer have respectively an upper uncovered zone and a lower uncovered zone corresponding to the hollow zone.

In yet another embodiment the upper light guide plate includes a top portion and a lateral portion connected to the top portion. The top portion and lateral portion form a housing space to hold the lower light guide plate.

In yet another embodiment the upper light guide plate has a plurality of installation apertures corresponding to the coupling portions and run through by the driven mechanisms for latching on the middle plate.

The keyboard of the invention thus formed, compared with the conventional keyboards, provides many advantages, notably:

1. The keyboard can be made thinner. With the driven mechanisms directly mounted onto the command circuit board, the baseboard used in the conventional keyboards can be omitted. Hence total thickness of the keyboard can be reduced.

2. Improved illumination effect. With the upper and lower light guide plates to transmit light, and the upper mask layer on the upper light guide plate to confine light transmission path, light projects merely towards the keycap portions.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the keyboard of the invention.

FIG. 2 is a cross section of the first embodiment taken on line 2-2 in FIG. 1.

FIG. 3 is a fragmentary cross section of the first embodiment taken on line 3-3 in FIG. 1.

FIG. 4 is a fragmentary cross section of a second embodiment taken on line 3-3 in FIG. 1.

FIG. 5 is a fragmentary cross section of a third embodiment taken on line 3-3 in FIG. 1.

FIG. 6 is a fragmentary cross section of a fourth embodiment taken on line 3-3 in FIG. 1.

FIG. 7 is a fragmentary cross section of a fifth embodiment taken on line 3-3 in FIG. 1.

FIG. 8 is a cross section of a sixth embodiment of the keyboard of the invention.

### DETAILED DESCRIPTION OF THE PREFERRED EMBODIMENTS

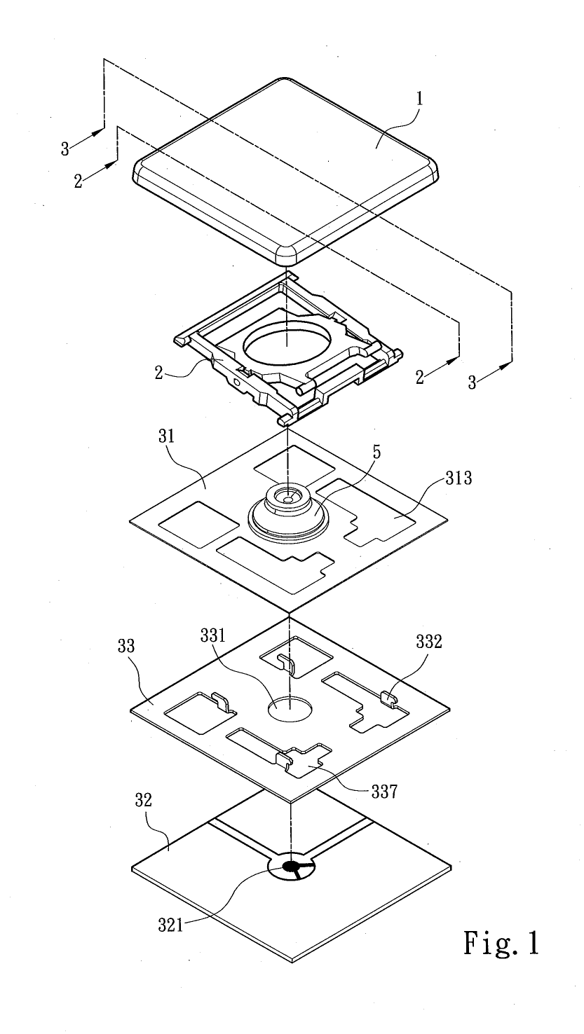

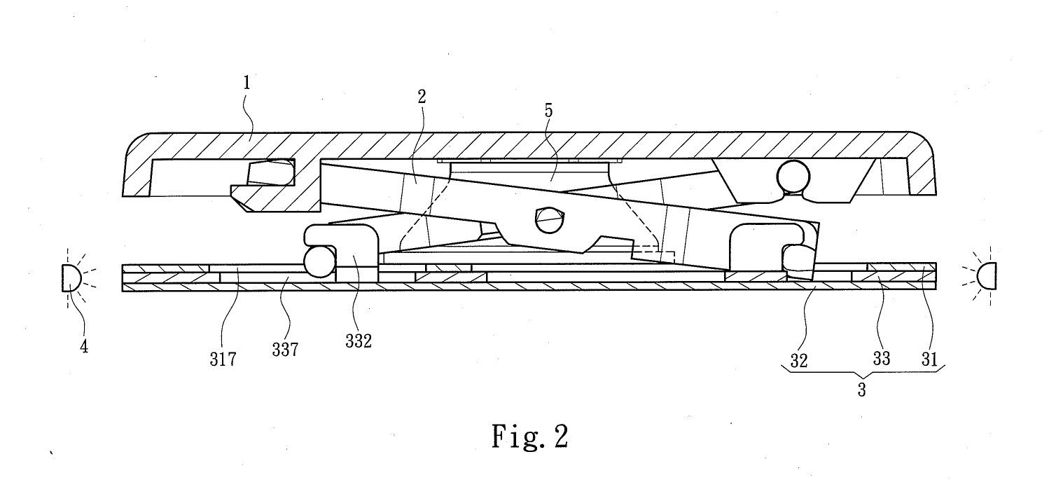

Please refer to FIGS. 1, 2 and 3, the present invention aims to provide a keyboard equipped with light emitting structure that comprises a plurality of keycap portions 1, a plurality of driven mechanisms 2, a light guide command circuit board 3 and a light emitting unit 4. Each keycap portion 1 corresponds to one driven mechanism 2 and is movable up and down against the command circuit board 3. Each driven mechanism 2 can be formed in a scissors structure or other similar structure commonly seen on the market. The command circuit board 3 includes an upper light guide plate 31, a lower light guide plate 32 and a middle plate 33. Moreover, the upper light guide plate 31 faces the keycap portion 1, and the lower light guide plate 32 is located below the upper light guide plate 31. The middle plate 33 is located between the upper light guide plate 31 and lower light guide plate 32. The upper and lower light guide plates have respectively an upper trigger portion 311 and a lower trigger portion 321 at one side facing the middle plate 33. The middle plate 33 has a hollow zone 331 corresponding to the upper and lower trigger portions 311 and 321 such that the upper trigger portion 311 and lower trigger portion 321 can be positioned correspondingly to each other. Each keycap portion 1 is depressible to press the upper trigger portion 311 so that the upper trigger portion 311 and lower trigger portion 321 are contacted through the hollow zone 331 to output a command signal. In addition, the middle plate 33 has a plurality of coupling portions 332 corresponding to each keycap portion 1 to couple with the driven mechanism 2. The coupling portion 332 can be a coupling structure such as a latch hook or an installation aperture or the like. Furthermore, the middle plate 33 has an aperture 337 corresponding to each coupling portion 332. In practice, the aperture 337 can be a punched hole formed in advance on the middle plate 33. In addition, the keyboard also can have a buffer support member 5 collaborating with the driven mechanism 2 and depressible by the keycap portion 1 to generate deformation. The upper light guide plate 31 also has a plurality of installation apertures 317 corresponding to the coupling portions 332 to allow the driven mechanism 2 to run through and latch on the middle plate 33.

In addition, the light emitting unit 4 can be held at two sides of the command circuit board 3 or in a housing space (not shown in the drawings) formed on the command circuit board 3. Furthermore, the upper light guide plate 31 has an upper mask layer 312 at one side facing the keycap portion 1. The upper mask layer 312 has a transparent zone 313 corresponding to each keycap portion 1. The upper mask layer 312 can be formed on the upper light guide plate 31 by physical or chemical coating in ink, or can be an opaque plate. Thus, the command circuit board 3 can receive light from the light emitting unit 4 and evenly transmit the light to illuminate the keycap portion 1 through the transparent zone 313. The ink used on the mask layer can be black ink or other ink with equivalent opaque effect.

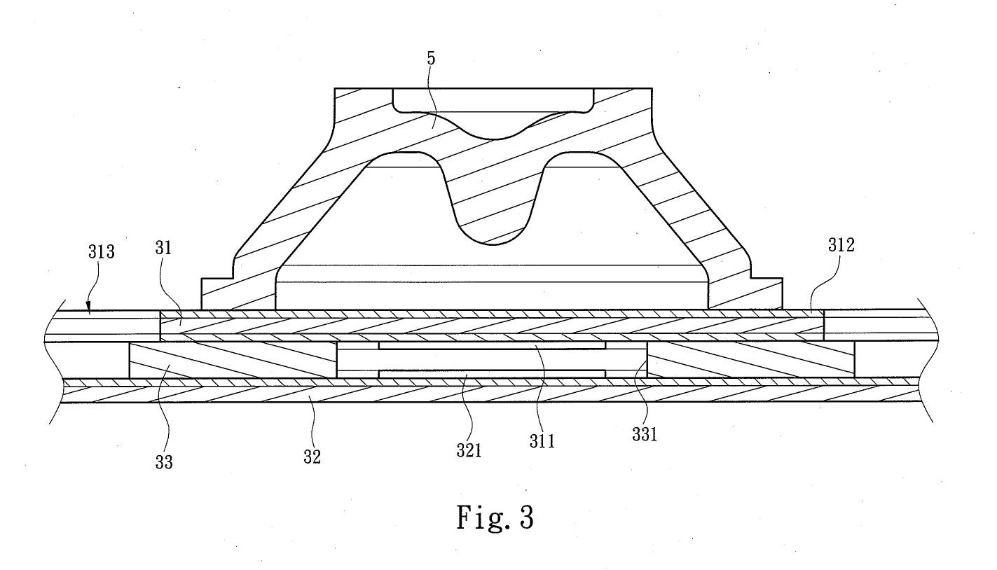

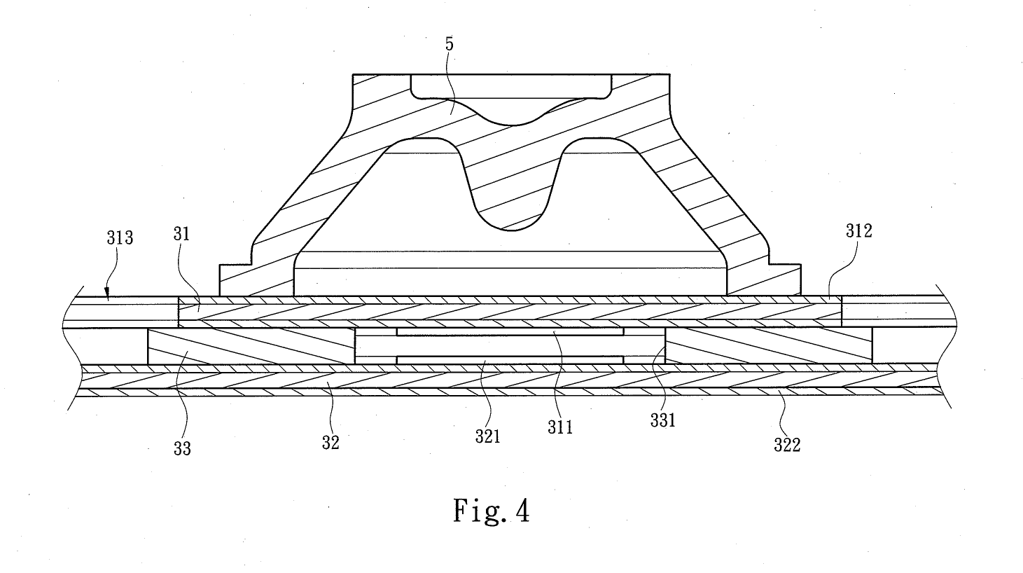

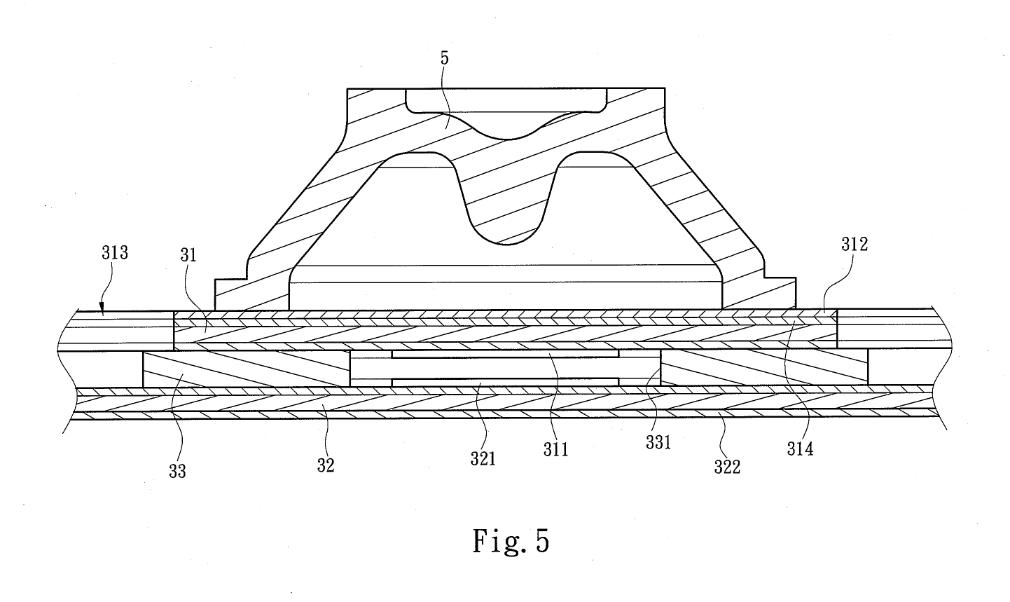

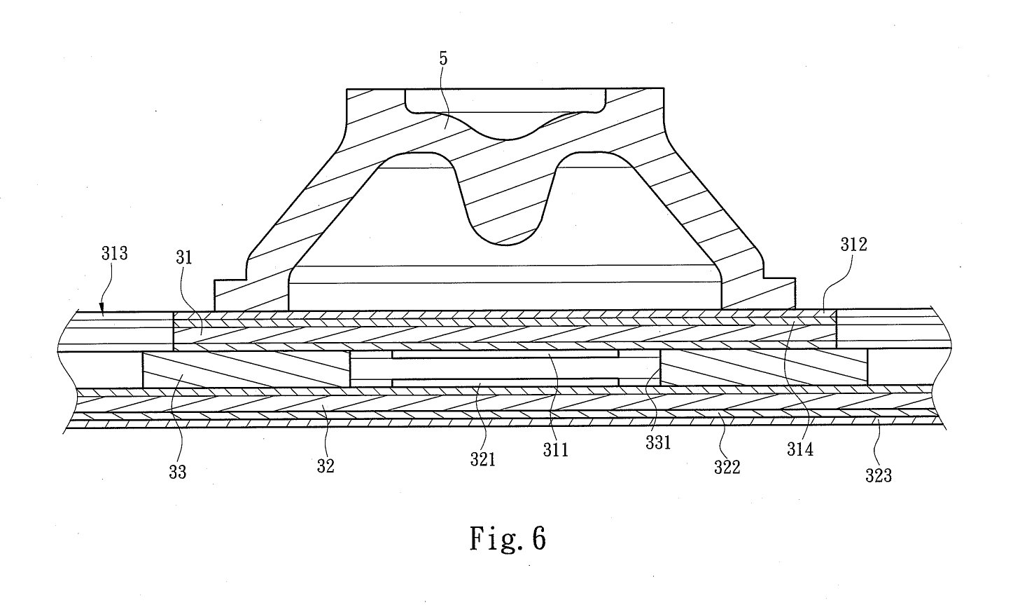

Please also refer to FIGS. 3 through 6, aside from forming the upper mask layer 312 on the upper light guide plate 31, the lower light guide plate 32 can also have a lower reflective layer 322 at one side facing the keycap portion 1 and opposing the lower trigger portion 321 so that the light transmitting in the lower light guide plate 32 can be reflected by the lower reflective layer 322 between the upper and lower light guide plates 31 and 32. The lower reflective layer 322 also can be formed on the lower light guide plate 32 by physical or chemical coating in ink, or can be a reflective plate. The reflective ink can be while ink or ink with equivalent reflective effect. Aside from the aforesaid embodiments, the lower reflective layer 322 can also be located at same side of the lower trigger portion 321. In addition, the upper light guide plate 31 can also have an upper reflective layer 314 below the upper mask layer 312 facing the upper trigger portion 311. The upper reflective layer 314 is not limited to be at one side of the upper mask layer 312, also can be at same side of the upper trigger portion 311. Or the lower light guide plate 32 also can have a lower mask layer 323 below the lower reflective layer 322, thereby the light not reflected by the lower reflective layer 322 can be masked by the lower mask layer 323. Thus, based on actual implementation requirements, the upper light guide plate 31 may have the upper mask layer 312 or upper reflective layer 314, or the lower light guide plate 32 may have the lower reflective layer 322 or lower mask layer 323. Through the reflective layers or mask layers, light transmission can be confined between the upper light guide plate 31 and lower light guide plate 32.

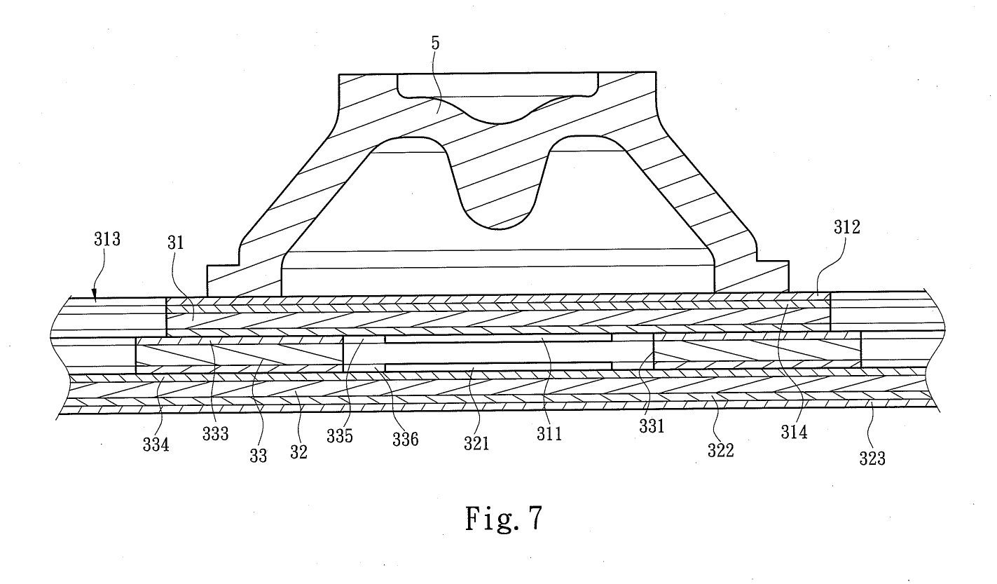

Please refer to FIG. 7, in practice, the middle plate 33 can be a transparent plate or a metal plate. To prevent faulty operation of the upper and lower trigger portions 311 and 321 due to the material of the middle plate 33, the middle plate 33 can further have an upper insulation layer 333 and a lower insulation layer 334 at one side respectively corresponding to the upper trigger portion 311 and lower trigger portion 321. The upper and lower insulation layers 333 and 334 have respectively an upper uncovered zone 335 and a lower uncovered zone 336 corresponding to the hollow zone 331. The upper and lower uncovered zones 335 and 336 allow the upper trigger portion 311 and lower trigger portion 321 to be triggered securely. The upper and lower insulation layers 333 and 334 can be formed on the middle plate 33 by coating insulation ink or disposing an insulation plate.

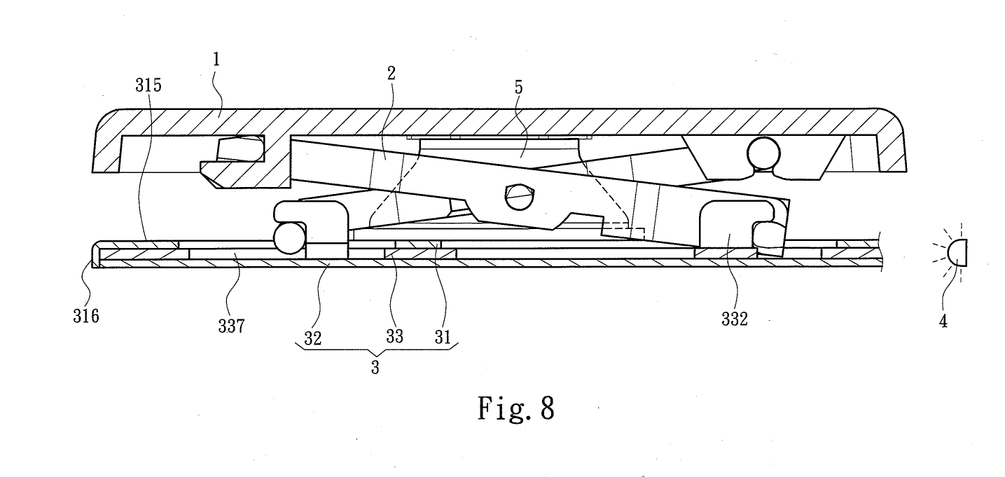

Please refer to FIG. 8 for another embodiment in which the upper light guide plate 31 has a top portion 315 and a lateral portion 316 which are formed by bending the upper light guide plate 31 in a vertical angle, thereby form a housing space between the top portion 315 and lateral portion 316 to hold the middle plate 33 and lower light guide plate 32. The lateral portion 316 can also be formed on one or two sides of the top portion 315, thereby the upper mask layer 312 on the lateral portion 316 can confine the light scattering from lateral sides of the lower light guide plate 32 without losing.

As a conclusion, the keyboard equipped with light emitting structure according to the invention includes a plurality of keycap portions, a plurality of driven mechanisms and a light guide command circuit board. The command circuit board includes an upper light guide plate, a lower light guide plate and a middle plate between the upper and lower light guide plates. The upper and lower light guide plates have respectively an upper trigger portion and a lower trigger portion at one side facing the middle plate that can be triggered to generate a command signal. The middle plate has a hollow zone corresponding to the upper and lower trigger portions, a plurality of coupling portions corresponding to the keycap portion to couple with the driven mechanism and a plurality of apertures corresponding to the coupling portions. The upper light guide plate also has an upper mask layer at one side facing the keycap portion that contains a transparent zone. Thereby the command circuit board can receive light from a light emitting unit and transmit the light to illuminate the keycap portion through the transparent zone. As a result, the keyboard can be made thinner.

What is claimed is:

1. A keyboard equipped with light emitting structure, comprising:
a plurality of keycap portions and a plurality of driven mechanisms each corresponding to one of the keycap portions;
a light guide command circuit board which includes an upper light guide plate, a lower light guide plate and a middle plate located between the upper light guide plate and the lower light guide plate, the upper light guide plate and the lower light guide plate including respectively an upper trigger portion and a lower trigger portion at one side thereof facing the middle plate, the middle plate including a hollow portion corresponding to the upper trigger portion and the lower trigger portion, a plurality of coupling portions corresponding to the keycap portion to couple with the driven mechanism and a plurality of apertures corresponding to the coupling portions, the upper light guide plate further including an upper mask layer at one side facing the keycap portion, the upper mask layer including a transparent zone corresponding to the keycap portion; and
a light emitting unit for providing light to the command circuit board which receives the light and evenly transmits the light to illuminate the keycap portion through the transparent zone.

2. The keyboard of claim 1, wherein the lower light guide plate includes a lower reflective layer at one side opposing the lower trigger portion.

3. The keyboard of claim 1, wherein the lower light guide plate includes a lower reflective layer at same side of the lower trigger portion.

4. The keyboard of claim 1, wherein the upper light guide plate includes an upper reflective layer below the upper mask layer.

5. The keyboard of claim 2, wherein the upper light guide plate includes an upper reflective layer below the upper mask layer.

6. The keyboard of claim 3, wherein the upper light guide plate includes an upper reflective layer below the upper mask layer.

7. The keyboard of claim 1, wherein the upper light guide plate includes an upper reflective layer at same side of the upper trigger portion.

8. The keyboard of claim 2, wherein the upper light guide plate includes an upper reflective layer at same side of the upper trigger portion.

9. The keyboard of claim 3, wherein the upper light guide plate includes an upper reflective layer at same side of the upper trigger portion.

10. The keyboard of claim 2, wherein the lower light guide plate includes a lower mask layer below the lower reflective layer.

11. The keyboard of claim 1, wherein the middle plate includes an upper insulation layer and a lower insulation layer at one side facing respectively the upper trigger portion and the lower trigger portion, the upper insulation layer and the lower insulation layer including respectively an upper uncovered zone and a lower uncovered zone corresponding to the hollow zone.

12. The keyboard of claim 2, wherein the middle plate includes an upper insulation layer and a lower insulation layer at one side facing respectively the upper trigger portion and the lower trigger portion, the upper insulation layer and the lower insulation layer including respectively an upper uncovered zone and a lower uncovered zone corresponding to the hollow zone.

13. The keyboard of claim 3, wherein the middle plate includes an upper insulation layer and a lower insulation layer at one side facing respectively the upper trigger portion and the lower trigger portion, the upper insulation layer and the lower insulation layer including respectively an upper uncovered zone and a lower uncovered zone corresponding to the hollow zone.

14. The keyboard of claim 1, wherein the upper light guide plate includes a top portion and a lateral portion connected to the top portion, the top portion and the lateral portion forming a housing space to hold the lower light guide plate.

15. The keyboard of claim 1, wherein the upper light guide plate includes a plurality of installation apertures corresponding to the coupling portions and run through by the driven mechanisms for latching on the middle plate.
